(19) United States
(12) Patent Application Publication
(10) Pub. No.: US 2025/0026431 A1
(43) Pub. Date: Jan. 23, 2025

(54) KIT FOR MOUNTING AN ACCESSORY ON HANDGRIPS OF A BICYCLE OR MOTORCYCLE

(71) Applicant: Crank Brothers, Inc., Laguna Beach, CA (US)

(72) Inventors: Michael Allan WRIGLEY, Laguna Beach, CA (US); Sebastien Carlachille SALVANT, Laguna Beach, CA (US)

(21) Appl. No.: 18/355,894

(22) Filed: Jul. 20, 2023

(51) Int. Cl. B62K 19/40; B62J 3/04; B62J 6/03; B62J 7/06; B62K 21/26

(52) U.S. Cl. CPC B62K 19/40; B62J 3/04; B62J 6/03; B62J 7/06; B62K 21/26

(57) ABSTRACT

The present invention relates to a kit for mounting an accessory on handgrips or handlebars of a bicycle or motorcycle as well as a bicycle or motorcycle including such a kit.

### TECHNICAL FIELD OF THE INVENTION

The present invention relates to a kit for mounting an accessory on handgrips of a bicycle or motorcycle as well as a bicycle or motorcycle provided with such kit. The accessory can be, for example, a handguard, a flashlight or a bell.

### STATE OF THE ART

Handguards have been commonplace in the motorsports industry for some time now on both on and off road motorcycles. The primary purpose of these guards is to protect the hands of a rider from anything which would make a frontal impact with their hands while riding. More recently, handguards have begun gaining popularity among mountain bikers as they face many of the same issues with objects hitting their hands while riding.

Another trend we have seen over the last few years is riders attempting to stream line their cockpits, and reduce the number of clamps on their bars. This is most obvious in the prevalent use of shifters and drop bar remotes that integrate directly with brake clamps, removing the need for an additional clamp to hold these levers. This integration becomes especially important on Ebikes, where the use of additional electrical hardware takes up space on the bars, and doesn't leave room for additional clamps.

It should be also considered that most bicycle handlebars have an outer diameter of 22.2 mm for attaching grips and other accessories. Many brands of grips use a nearly identical lock on grip clamp interface with a 26.6 mm inner diameter clamp diameter, which clamps a flange on the grip in order to lock the grip into position onto the handlebar.

Thus, a solution mountable on handgrips of various sizes would be needed.

Moreover, since the handguards and even other accessories are mounted directly to the rider's handgrips, it is needed to provide a highly flexible attachment method.

With reference to such an aspect, while the guards are attached directly to the clamps that lock on the grips, they handguards need to be able to rotate independently of the grips so riders can optimize the rotation of both parts independently. Note that many grips have contours and surface patterns to optimize contact with different parts of a hand which means that there is often an optimal rotational orientation for the grip. This becomes even more important when adapting the clamp to integrate with the grips of multiple other brands, as the rotational position of the clamp varies from brand to brand.

Another consideration to be made is that due to the variance in grip length, as well as rider preferences, adjustments are an important part of the handguard design.

### SUMMARY OF THE INVENTION

It is therefore a principal object of the present invention to provide a new kit for mounting an accessory, such as for example a handguard, a bell or a flashlight, on handgrips of a bicycle or motorcycle.

Another object of the present invention is to provide a new kit as above indicated which is adaptable and mountable to lock on grips of various sizes.

Another object of the present invention is to provide a new kit, which is capable of optimizing space and reduce bulk on the handlebars.

Another object of the present invention is to provide a new kit, which can be adjusted in a simple and efficacy manner.

Another object of the present invention is to provide a new kit for installing and removing quickly and easily accessories.

Another object of the present invention is to provide a new kit as above indicated for mounting handguards in an adjustable manner, so that it is possible to accommodate larger or smaller brake reservoirs, while maintaining the same vertical position and angle of the handguard.

Another object of the present invention is to provide a new bicycle or motorcycle with a kit as above indicated.

According to the present invention a kit as described in the present application is provided.

According to the present invention a bicycle or motorcycle as described in the present application is provided.

According to the present invention a use of a kit as above indicated for mounting a handguard, a bell or a flashlight on a handgrip or on a handlebar of a bicycle or motorcycle is even provided.

The present application refers to preferred and advantageous embodiments of the invention.

### BRIEF DESCRIPTION OF THE DRAWINGS

These and other advantages will be better understood by any man skilled in the art from the following description and from the attached drawings, given as a non-limiting example, in which:

FIG. 1 shows a kit according to the present invention for mounting an accessory, such as a handguard on a handgrip of a bicycle or motorcycle as well as it partly shows the bicycle itself,

FIG. 2 is an exploded view of the kit of FIG. 1,

FIGS. 3 and 4 are perspective views, from respective sides, of a kit according to the present invention,

FIGS. 5 to 7 are perspective views, from respective sides, of a clamp of a kit according to the present invention,

FIGS. 8 and 9 show shims of a kit according to the present invention,

FIGS. 10 and 11 show a detail of the connection among clamp and arm of a kit according to the present invention,

FIGS. 12 and 13 are exploded views showing a detail of the connection among clamp and arm of a kit according to the present invention,

FIGS. 14 and 15 show a detail of the connection among accessory and arm of a kit according to the present invention,

FIGS. 16 and 17 show two connection positions of an accessory on an arm of a kit according to the present invention,

FIGS. 18 and 19 show a kit according to the present invention for mounting a flashlight or bell, respectively, on a handgrip of a bicycle or motorcycle,

FIG. 20 shows a bicycle according to the present invention,

FIG. 21 illustrates a detail on an enlarged scale of FIG. 20, and

FIGS. 22 to 24 show different handgrips to be used with a kit of the present invention for obtaining a bicycle according to the present invention.

### DETAILED DESCRIPTION

The present invention relates to a kit or equipment or set of components 1 for mounting an accessory 2 on handgrips 6 of a bicycle or motorcycle 3, as well as a bicycle or motorcycle including at least one of such kit 1 mounted on a respective handgrip 6 or the respective handlebar 4 or preferably two kits 1 each mounted on a respective handgrip 6.

More particularly, the kit 1 comprises a clamp 5 to be mounted on handgrips 6 of a bicycle or motorcycle, which clamp includes an outer 5a and an inner 5b surface delimiting a through opening TO extending along a first axis x-x.

The kit 1 further comprises at least one element for tightening 7 the clamp 5 or rather the respective inner surface 5b on a handgrip 6.

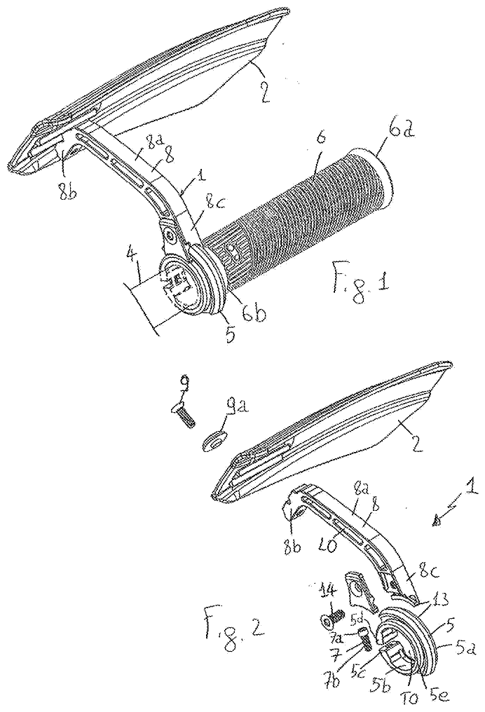

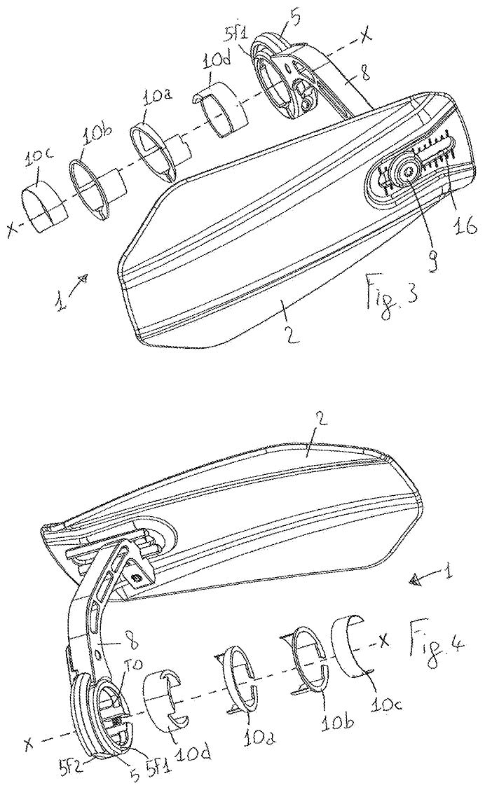

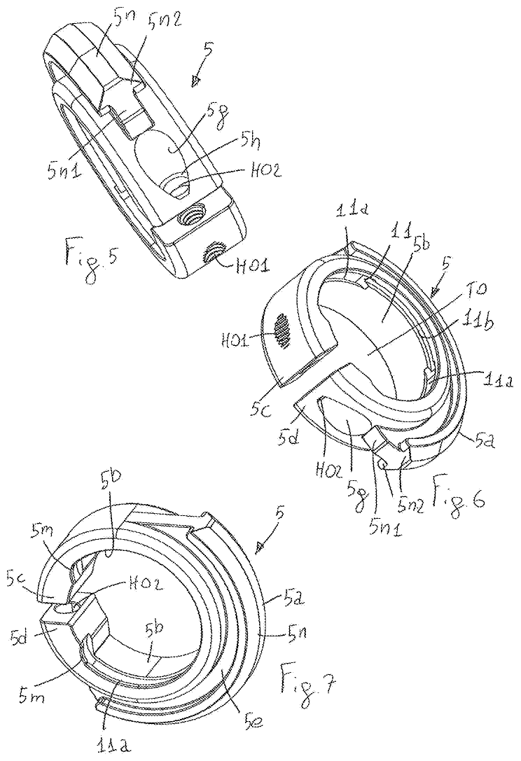

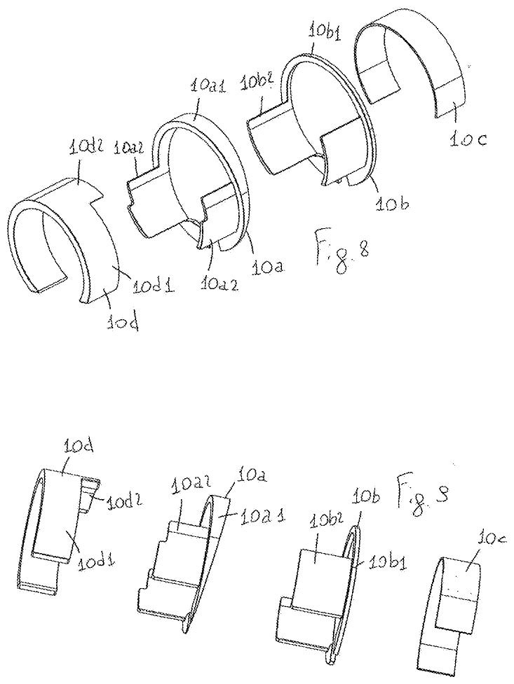

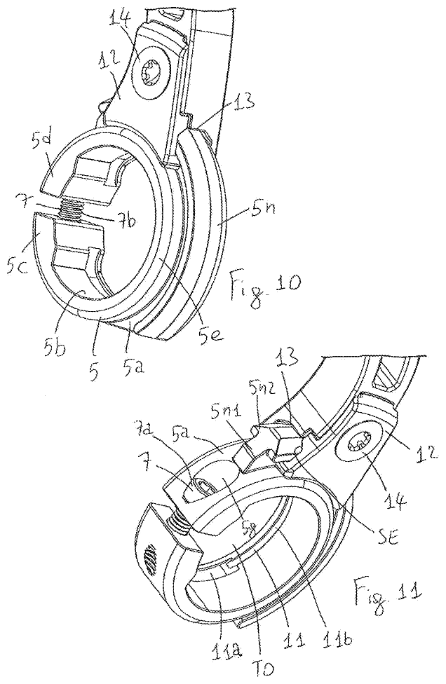

To this regard, in accordance with the not limiting embodiment shown in the figures, the clamp 5 comprises or consists of a C-shaped component or an annular main shape without a respective section or portion, with two free ends 5c-5d facing each other and moveable, i.e., approachable or removable with respect to each other by means of the element for tightening 7 among at least one far removed position (see FIG. 2) and at least one close or clamping position (see FIG. 1). As it will be understood, the clamp 5 is fitted on a handgrip 6 with the ends in the far-removed position, and then the element for tightening 7 is actuated so as to approach the ends 5c, 5d and thus tighten the clamp 5 on a handgrip 6.

Preferably, the clamp 5 is elastically displaceable (in contrast with the action of the element for tightening 7) among the now described positions or arrangements.

The ends 5c-5d could be enlarged with respect to the other parts of the clamp 5. More particularly, such ends 5c-5d could have a thickness gradually decreasing or tapered towards the intermediate portion 5e of the clamp 5 itself, so as to define respective steps 5m, which, if desired, are radiused.

The element for tightening 7 can include a screw, a bolt, a rivet or the like. With reference to the not limiting embodiment shown in the figures, in both the ends 5c, 5d of the clamp 5 a through hole or opening HO1, HO2 is delimited, in such a way as the first hole or opening HO1 is substantially aligned to the second hole or opening HO2, so that the element for tightening or screw 7 is inserted and tightened in such aligned holes or openings HO1, HO2. As an alternative, one of the holes or openings HO1, HO2 could be blind.

Of course, if the element for tightening 7 includes a screw or threaded bolt, one or both the holes or openings HO1, HO2 is/are internally threated. To this regard, the clamp 5 can delimit a notch 5g with one hole or opening HO2 departing from such notch 5g up to a respective end 5d, so that the notch 5g delimits a shoulder 5h for a head 7a of the element for tightening 7, whose stem 7b extends in the hole or opening HO2 up to reach and engage, in use, the other hole or opening HO1. Of course, such shoulder 5h faces away from the zone among the ends 5c, 5d.

Furthermore, the kit 1 includes an accessory arm or guard arm 8 enbloc with or fixed or removably mountable on the clamp 5 and designed to support the accessory 2.

If the accessory arm or guard arm 8 is removably mountable on the clamp 5, then the kit 1 includes at least one element for connecting 9 an accessory 2 to the arm 8. The at least one element for connecting 9 can include a screw, a bolt, a rivet or the like. If desired, a washer 9a is also provided to be mounted among the head of the element for connecting 9 and a respective surface of the accessory 2.

With reference to the not limiting embodiment shown in the figures, the arm 8 has two or more sections one inclined with respect to the other. More particularly, the guard arm 8 can have a main straight section 8a and a terminal section 8b for connection to an accessory 2, which is inclined or curved with respect to the main straight section 8a, if desired, inclined by an angle among 60° and 120° or 70° and 110°.

Moreover, the arm 8 could also include a base section 8c of connection to the clamp 5, which base section 8c can be curved or inclined with respect to the main straight section 8a.

The accessory arm or guard arm 8 can delimit one or more lightening openings LO, if desired through, which openings can be mainly provided, for example, at the main straight section 8a.

The main extension axis of the main straight section 8a, of the terminal section 8b, and, if provided, of the base section 8c could lie in a plane substantially orthogonal to the first axis x-x, which, in use, substantially corresponds to the main extension or longitudinal axis of the handgrip 6.

The kit 1 is even provided with at least two shims or spacers 10a-10d having a different thickness and/or shape one with respect to the other, so that the kit 1 is suitable for making it possible to mount an accessory on two or more handgrips with shape and/or size different from—for example higher or lower than—one another. To this regard, each shim or spacer has a shape and/or size specific for one or more respective handgrips.

In this respect, as it is known, a handgrip 6 has a core 6a, usually made of plastic or the like and a padding or covering 6b applied or mounted or formed on the core.

Moreover, the handgrip 6 has a main tubular body, if desired closed at a first 6c, whereas the other or second end 6d is open and fitted on a handlebar 4.

At the second end 6d, the core 6a can have a portion 6e protruding from the padding 6b, although this is not needed.

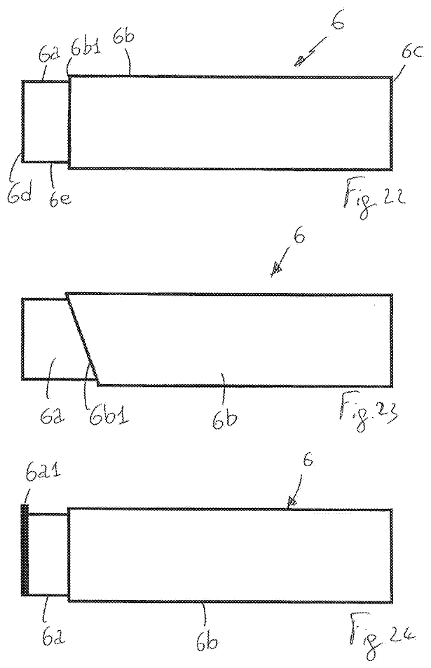

The padding or covering 6b could have an end 6b1 close to the second end 6d, which lies in a plane orthogonal to the main longitudinal axis of the handgrip 6 (see FIG. 22) or even inclined with respect to such plane or rather to the plane where lies the second end 6d (FIG. 23).

Moreover, the core 6a can have a flanged-like end 6a1 (FIG. 24). The flanged-like end 6a1 can be annular or partly annular, i.e. with sectioned or removed terminal portions.

The clamp 5 is preferably mounted on the core 6a of a handgrip 6 at a second end 6d or, if provided, at the protruding portion 6e of the core 6a.

Advantageously, the inner surface 5b of the clamp 5 defines at least one recessed portion 11 suitable for housing at least one portion of a handgrip 6, if provided, a flanged-like end 6a1 thereof.

Preferably, the at least one recessed portion 11 has at least one first section 11a with a first width and/or depth, and at least one second section 11b with a second width and/or depth lower than the first width and/or depth.

Advantageously, the kit 1 comprises at least three shims or spacers 10a-10d.

The inner surface 5b substantially lies on a cylindrical surface and the recessed portion 11 can extend along or is coaxial to the axis of symmetry of such cylindrical surface, which axis, in use, corresponds to the first axis x-x.

Advantageously, the recessed portion 11 includes, from one end or from a zone proximal to one end 5c to the other end or to a zone proximal to the other end 5d, a first section 11a, then a second section 11b and subsequently another first section 11a. Thus, the first section 11a could include one or more parts of the curved extension of the recessed portion, whereas the second section 11b includes the other parts thereof, although the second section 11b has a width less than the first section 11a.

With reference to the not limiting embodiment shown in the figures, the second section 11b extends among ¼ and ½ the width of the recessed portion 11.

The first section/s 11a could have the same depth of the second section 11b or they can have a different depth.

The recessed portion 11 could not extend along or until the ends 5c-5d of the clamp 5.

The recessed portion 11 is useful for mounting the clamp 5 on a handgrip with a core 6a having a flanged-like end 6a1 (see FIG. 24).

One or each of the shims could include a C-shaped body extending along a substantially curved arc or length about a central or longitudinal axis, which, in use, is substantially aligned to the first axis x-x.

To this regard, the shims could include a first shim 10a shaped so as to be mountable at least partly in the inner surface 5b.

More particularly, the first shim 10a has a main C-shaped section 10a1 and one or more (two in the figures) protruding sections 10a2 extending from an edge of the main C-shaped section 10a1.

The main C-shaped section 10a1 and at least partly the protruding section/s 10a2 are designed to be mounted on a handlebar 4, whereas the protruding section/s 10a2 is designed to be mounted or rather inserted in the inner surface 5b of the clamp 5, with the main C-shaped section 10a1 abutting against one 5f1 of the sides 5f1, 5f2 of the clamp 5.

The first shim 10a or rather the respective main C-shaped section 10a1 has a thickness, i.e. an extension parallel to the central or longitudinal axis of the shim, which can be constant or even it can vary from one end to the other; if desired, the thickness could be minimum at the ends and maximum at the central part or viceversa.

Moreover, the first shim 10a or rather the respective main C-shaped section has a first width, i.e. the distance of the respective inner surface from the respective outer surface. Such first width is preferably constant, although the free edges of the main C-shaped section could be enlarged.

In this respect, the outer surface and the inner surface of the shim 10a could be not concentric, but, for example actually tangent to each other.

The protruding section/s 10a2 has/have a width lower, for example among ⅙ and ½, than the width of the main C-shaped section 10a1. In this respect, the protruding section/s 10a2 can extend from an inner edge of the main C-shaped section 10a1, so that the inner surface delimited by the protruding section/s 10a2 is preferably aligned to the inner surface delimited by the main C-shaped section 10a1.

The outer surface of the protruding section/s 10a2 has a cross-section lower, preferably slightly lower than the inner surface 5b, so that the protruding section/s 10a2 can be inserted and mounted in the inner surface 5b. The outer surface of the main C-shaped section 10b1 has instead a cross-section greater than the inner surface 5b.

Each protruding section 10a2 preferably comprises a curved wall or wall section with an extension lower than the extension of the inner edge of the main C-shaped section 10a1, so that each protruding section engages or lines a portion only of the inner surface 5b. If two or more protruding sections 10a2 are arranged, the same are preferably aligned along an ideal tubular area.

The first shim 10a can be mounted, for example, on a handgrip as that shown in FIG. 23.

The shims could even include a second shim 10b shaped so as to be mountable at least partly in the inner surface 5b.

More particularly, the second shim 10b has a main C-shaped section 10b1 and one or more (two in the figures) protrusions 10b2 extending from an edge of the main C-shaped section 10b1.

The main C-shaped section 10b1 and at least partly the protrusion/s are designed to be mounted on a handlebar 4, whereas the protrusion/s 10b2 is/are designed to be mounted or rather inserted in the inner surface 5b of the clamp 5, with the main C-shaped section 10b1 abutting against a side 5f1 of the clamp 5.

Moreover, the second shim 10b has a second width, i.e. the distance of the respective inner surface from the respective outer surface. Such second width is preferably constant, although the free edges of the main C-shaped section could be enlarged.

In this respect, the outer surface and the inner surface of the shim 10b could be not concentric, but, for example actually tangent to each other.

The thickness of the second shim 10b or rather of the main C-shaped section 10b1 could be constant or even it can vary from one end to the other.

The protrusion/s 10b2 has/have a width lower, for example among ⅙ and ½, than the width of the main C-shaped section 10b1. In this respect, the protruding section/s 10b2 can extend from an inner edge of the main C-shaped section 10b1, so that the inner surface delimited by the protruding section/s 10b2 is preferably aligned to the inner surface delimited by the main C-shaped section 10b1.

The outer surface of the protrusion/s 10b2 has a cross-section lower, preferably slightly lower than the inner surface 5b, so that the protrusion/s 10b2 can be inserted and mounted in the inner surface 5b. The outer surface of the main C-shaped section 10b1 has instead a cross-section greater than the inner surface 5b.

Each protruding section preferably comprises a curved wall or wall section with an extension lower than the extension of the inner edge of the main C-shaped section 10b1, so that each protruding section engages or lines a portion only of the inner surface 5b. If two or more protrusion 10b2 are arranged, the same are aligned along an ideal tubular area.

The second shim 10b can be mounted, for example, on a handgrip as that shown in FIG. 22.

In addition or alternative to the above, the shims could include a third shim 10c shaped so as to be mountable at the inner surface 5b.

Moreover, the third shim 10c has a third thickness and/or size, i.e. the distance of the respective inner surface from the respective outer surface.

Advantageously, the third shim 10c has a thickness equal or even slightly more or less than the first 10a and second 10b shims, for example from about ½ and 2 the thickness of such shims 10a, 10b or rather of the protruding section/s or protrusion/s 10a2, 10b2.

The third shim 10c is preferably used with a handgrip having a flanged-like end (see FIG. 24), so that such flanged-like terminal end is caused to enter into the recessed portion 11, whereas the third shim 10c is mounted on the protruding portion 6e of the handgrip 6 among such flanged-like end 6a1 and the end 6b1 of the padding or covering 6b close to the second end 6d.

According to the not limiting embodiment shown in the figures, the shims include a fourth shim 10d shaped so as to be mountable at the inner surface 5b.

If desired, the fourth shim 10d could include a projecting section 10d2 extending from an edge of the main body 10d1.

In this respect, the thickness of the fourth shim 10d is preferably equal or greater than the thickness of the first 10a and second 10b shims.

The fourth shim 10d could be used for mounting the clamp 5 and thus the accessory 2 directly on a handlebar 4 with no handgrip 6 or on a handgrip 6, if desired a handgrip with a flanged-like end, and thus it can be used in two manners.

As it will be understood, each of the shims defines, more particularly as soon as mounted in the clamp 5, a respective through opening and thus makes it possible to mount the accessory on a respective handgrip.

Advantageously, each shim 10a-10d is mounted in the inner surface 5b, when the element for tightening 7 is removed or loosened. Moreover, such assembling process could for example include a step of insertion of one of the shims 10a-10d in the clamp 5.

Of course, a shim 10a-10d is inserted with the respective free ends substantially aligned, as much as possible, to the free edges 5c, 5d of the claim 5.

As a matter of fact, the shims 10a-10d is used to fill the empty space left by the size difference of the clamp 5 with respect to the handgrip 6 or rather to the respective second end 6d, creating an effective clamp.

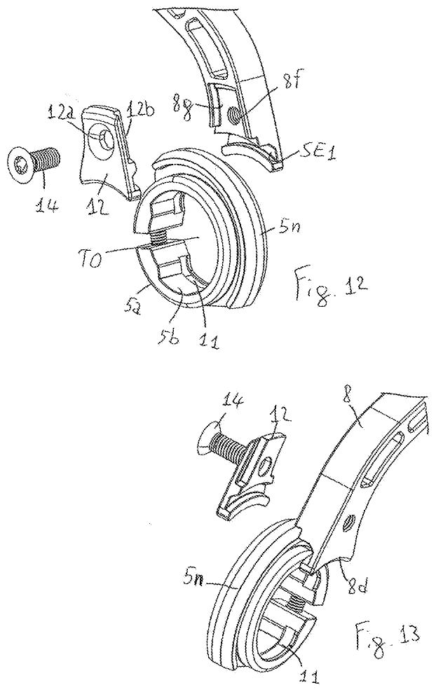

Preferably, the accessory or guard arm 8 and the clamp 5 include mutual connecting components or portions 13, so that the guard arm 8 can be assembled/disassembled to/from the clamp 5 due to such mutual connecting components or portions 13 even after that the clamp 5 has been mounted on a handgrip 6 or a handlebar 4 owing to the element for tightening 7 and thus the assembly/disassembly step of the accessory arm or guard arm 8 to/from the clamp 5 is irrespective from the mounting/dismounting step of the clamp 5 on a handgrip 6 (see in particular FIGS. 10 to 13) or a handlebar 4. As it will be understood, such an advantageous feature is useful irrespectively from the fact that the clamp is mounted directly on a handgrip or even on a handlebar.

In this respect, the clamp 5 can include a protruding portion or seat 5n, whereas the arm 8 is mountable on the protruding portion or seat 5n by means of at least one screw, bolt or rivet 14 or even by snap-fitting, forced fitting or in another suitable manner.

If desired, the clamp 5 includes a protruding portion, whereas the kit can advantageously comprise a plate 12, and in such case the protruding portion 5n is clamped among the plate 12 and a respective edge 8d at the base section 8c of the guard arm 8, whereas the at least one screw, bolt or rivet 14 is inserted in holes 8f, 12a and/or slots aligned of the plate 12 and the guard arm 8.

In this respect, with reference to the not limiting embodiment shown in the figures, an edge 8d of the guard arm 8 delimits part SE1 of the seat for the protruding portion 5n, whereas the plate 12 delimits another part SE2 of such seat, so that as soon as the plate 12 is abutted against the edge 8d of the guard arm 8 a complete seat SE for the protruding portion 5n is delimited.

The edge of connection 8d alone or with the plate 12 can include or define a shape substantially complementary to the protruding portion 5n.

In this respect, the edge 8d could have a portion with a shape matching with the shape of part of the optional plate 12, for example with a portion of one of such elements 8d or 15 suitable for being partly inserted in a portion of the other 15 or 8a.

The protruding portion 5n can includes a curved rib or the seat includes a curved housing, whereas the arm 8 has an edge of connection 8d slidingly mountable (alone or through a possible plate 12) along the curved rib 5n or housing, so that the mounting position of the arm 8 with respect to the clamp 5 can be adjusted by sliding the edge of connection 8d along the curved rib 5n or housing.

Such adjustment is advantageously obtainable along a circular path with a center lying, in use, on the first axis x-x.

The curved rib or the seat 5n, if provided, can extend or be formed at the outer surface 5a of the main C-shaped body of the clamp 5.

The curved rib or the seat 5n, if provided, can extend for a length among ⅙ and ⅔ of the main C-shaped body of the claim 5.

The cross-section of the protruding portion 5n could include a base segment 5n1 directly extending from the outer surface 5a, and a terminal segment 5n2 larger than the base segment 5n1 so as to define with the latter a step facing the outer surface 5a. The cross-section of the protruding portion 5n could for example be I-beam-shaped or T-shaped, with the head of the T being constituted by the terminal segment 5n2.

So far as in detail the not limiting embodiment of the edge of connection 8d and of the plate 12 is concerned, the edge of connection 8d delimits a curved part or half SE1 of the seat, whereas the plate 12 delimits the other curved part or half SE2 of the seat for the protruding portion 5n.

Advantageously, the arm 8 could delimit/include, around a respective hole or slot 8f, a hollow 8g or projecting zone, whereas the plate 12 could include/delimit an embossed or sunken 12a portion around a respective hole or slot 12b, which portion 12a is designed to engage or match the hollow or projecting zone 8f, for example to size or snap-fitting.

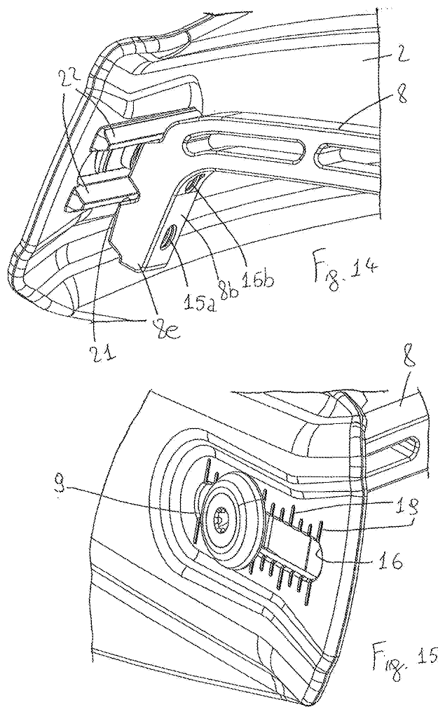

Preferably, the accessory or guard arm 8 delimits at least two connection holes or at least one slot 15a, 15b (see in particular FIGS. 14 to 17), for example two threaded holes 15a, 15b at the terminal end 8b distal from the clamp 5 and designed to constitute a mounting end for an accessory 2. The element for connecting 9 an accessory 2 to the arm 8 is engageable in each of the at least two connection holes or at least one slot 15, so that it is possible to mount an accessory in at least two different arrangements with respect to the guard arm 8.

Advantageously, the connection holes 15a, 15b are formed a first hole 15a at a position proximal to the free end 8e of the terminal end 8b of the arm 8 and the other 15b at a position distal from such free end 8e or rather at a distance from the latter greater than the first hole 15a.

As an alternative, the accessory or guard arm 8, at the terminal end 8b, delimits a slot with an extension greater than a hole, i.e. a narrow, elongated depression or groove or slit.

According to a less preferred alternative, the accessory or guard arm 8 delimits one connection hole or slot only at the terminal end 8b.

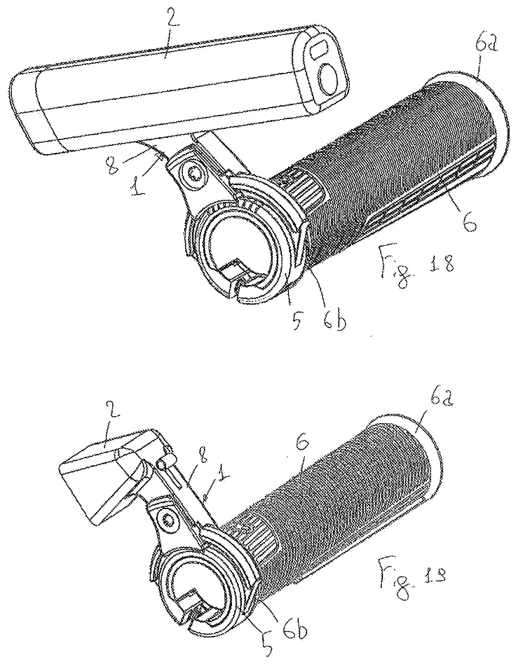

The kit 1 can also include an accessory 2, for example a handguard (see FIG. 1), a flashlight (see FIG. 18) or a bell (see FIG. 19).

If the accessory is a handguard 2, the same can be for example plate-shaped, if desired with a curved extension or two or three portions slightly inclined with respect to one another.

The handguard 2 or even another accessory could be made of any suitable material, for example of plastic.

The accessory 2 preferably delimits a hole or preferably a slot 16 (i.e. a narrow, elongated depression or groove or slit with an extension greater than a substantially cylindrical hole) or a number of holes for receiving the at least one element for connecting 9 in a number of positions, thereby ensuring different assembling positions of the accessory on the kit, and, in turn, on a handgrip 6 or handlebar 4. The slot 16 could extend or the holes can be aligned, in use, parallel to the first axis x-x.

Moreover, one or more reference components 19 could be formed or provided at the slot 16, if provided, for example along the perimeter of the slot 16, which component/s 19 is/are suitable for providing a user with information concerning the mutual position of the accessory or handguard 2 with respect to the arm 8, and in turn, to the handgrip 6 or handlebar 4. Such reference means 19 could include notches, numbers, lugs or the like means.

Advantageously, the kit 1 further includes at least one positioning component 21, 22 designed to provide a mutual engagement of the accessory or handguard 2 on/to the arm 8 to be fixed or stabilized through the at least one element for connecting 9. Thus, the at least one position component 21, 22 helps a user during the connection step of the accessory or handguard 2 on/to the arm 8.

In this respect, the terminal end 8b could delimit one or more hollow zones 21, whereas the accessory 2 includes, at a surface designed to be faced towards or abutted against the terminal end 8b, one or more lug components 22 to be engaged or fitted, for example to size or snap-fitted, each in a respective hollow zone 21.

As an alternative, the hollow zone/s is/are formed at the accessory 2, whereas the lug component/s is/are provided in the terminal end 8b.

The lug component/s 21 could be suitably shaped, for example tapered, if provided in the accessory 2, in a direction moving away from the latter, and if provided in the terminal end 8b, in a direction moving away from the latter.

The hollow zones 22 could be suitably shaped, for example tapered, if provided in the terminal end 8b, in a direction moving away from the accessory 2, and if provided in the accessory 2, in a direction moving away from the terminal end 8b.

With reference to the not limiting embodiment shown in the figures, at least one lug component 22 has a main extension direction substantially parallel to the main extension of the slot 16 or to the direction of alignment of the holes in the accessory 2.

Advantageously, the length of the at least one lug component 22 along such main extension is substantially equal to the length of the slot 16 along the respective main extension or the ratio among such length ranges for about 0.5 and 1.5, more preferably 0.8 and 1.2.

Preferably, two lug components 22 are provided, one extending below and the other extending above the slot 16 or lines of holes in the accessory 2, whereas the terminal end 8b could delimit at least two hollow zones 21, one above a hole or slot 15a, 15b, and the other below the hole or slot 15a, 15b.

More preferably, if two (if desired, through) holes 15a, 15b are delimited in the terminal end 8b, three lug components 22 can be provided, a first one extending below a hole 15a, a second extending above the other hole 15b, and a third extending between the holes 15a, 15b.

In such case, the mutual engagement of the first and second leg components 22 with the hollow zones 21, ensures one of the holes 15a to be open and engageable by the element for connecting 9, whereas the mutual engagement of the second and third leg components 22 with the hollow zones 21, ensures another of the holes 15b to be open and engageable by the element for connecting 9.

So far as the material of the kit are concerned, the same can be made in any suitable material, for example:
the shims 10a-10d can be made of plastic such as, for example, polypropylene,
the clamp 5 can be made of aluminum,
the guard arm 8 can be made of aluminum, and/or
the accessory 2 can be made of plastic, such as, for example, polypropylene.

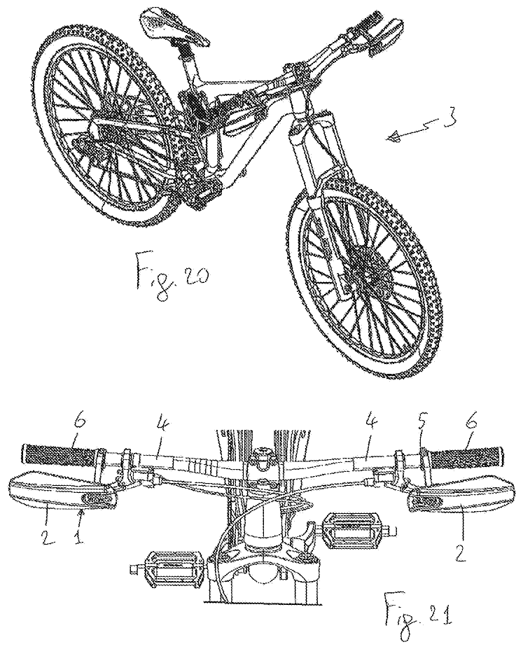

Subject-matter of the present invention is also a bicycle or motorcycle (see FIG. 20) including a handlebar 4 as well as two handgrips 6 mounted on such handlebar 4 and at least one kit 1, and in such case, the clamp 5 is mounted on one handgrip 6 with at least one of the shims or spacers 10a-10c mounted or assembled therein or at the respective inner surface 5b and directly in contact with the handgrip 2 or rather with the core 6a thereof. As an alternative the clamp 5 is mounted on the handlebar 4, optionally with one 10d of the shims or spacers mounted or assembled therein or at the respective inner surface 5b.

Subject-matter of the present invention is also the use of a kit as above indicated for mounting a handguard, a bell or a flashlight on a handgrip or on a handlebar of a bicycle or motorcycle.

Of course, the clamp 5 could also be mounted on the handlebar 4 and not on the handgrip 6 with the shim or spacer 10d mounted or assembled therein or at the respective inner surface 5b.

As it will be understood, with handgrips having specific size, no shim 10a-10d is needed.

Anyway, the shims 10a-10d are advantageous but not mandatory components of the present invention.

Therefore, the present invention relates to a kit advantageously:
1) with a clamp 5 adaptable and mountable to lock on handgrips of various sizes by means of special shims, and optionally by machining or obtaining a recessed portion 11 on the inside of the clamp 5;
2) with means suitable for mounting an accessory, such as a handguard directly to the clamp to optimize space and reduce bulk on the handlebars;
3) with means for making it possible to adjust laterally and/or vertically an accessory,
4) owing to which it is possible to adjust the accessory arm or guard arm, for example to accommodate larger or smaller brake reservoirs while maintaining the same vertical position and angle of the (plastic) guard,
5) ensuring a quick and easy installation and removal of accessories on a handgrip via a lock on grip clamp that can stay on the bicycle or motorcycle, for example bicycle or motorcycle independently of the removable accessories.

### 1. Clamp Adaptable and Mountable to Lock on Handgrips of Various Sizes by Means of Special Shims, and Machining on the Inside of the Clamp

Owing to the present invention, if two or more shims 10a-10d and optionally a recessed portion 11 are present, it is possible to adapt a single clamp 5 to many different brands of grips that have different flange design.

So for example a grip with a 26.6 mm outer flange diameter does not need any shim or the fourth shim 10d, whereas the clamp being used with a grip that has a smaller 25ish mm diameter, could be used together with the first 10a or second 10b shim.

By way of example, four different shims have been shown allowing the same clamp 5 to accommodate a number of handgrips. One of the shims, for example the fourth shim 10d can also allow the clamp 5 to be mounted directly to the handlebars without the use of a handgrip.

### 2. Handguards Mountable Directly to the Clamp to Optimize Space and Reduce Bulk on the Handlebars

According to the present invention, a rotational adjustment flexibility is advantageously achieved owing to the protruding portion 5n, mainly referring to the case where a T-shaped or I-beam clamp 5 is used running around the outer edge of the clamp. The guard arm and clamp plate slot into that I beam using it as a rail. They can slide freely along the rail until the screw or bolt are tightened, at which point the arm 8 is locked into place.

### 3. Working of the Handguards can be Adjusted Laterally or Vertically

If the accessory delimits a slot 16, it is possible to obtain a lateral adjustment of the position of the accessory. This allows for infinite adjustability within a certain range.

Moreover, should the protruding portion 5n be provided and shaped as a curved rib or a seat is arranged shaped as a curved housing, a vertical adjustment of the position of the accessory is obtainable.

Thus, the accessory, such as a handguard can be adjusted vertically by rotating the handguard up or down. This does adjust the angle of the guard slightly.

4. Guard Arms can be Adjusted to Accommodate Larger or Smaller Brake Reservoirs/Controls while Maintaining the same Vertical Position and Angle and the Plastic Guard

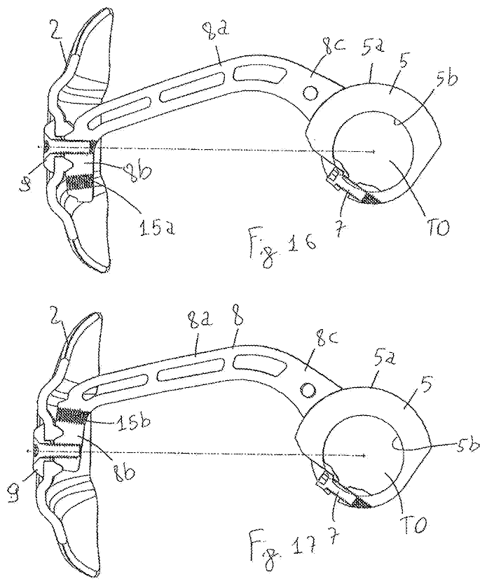

If the guard arm 8 delimits at least two connection holes or slot/s 15a, 15b at the terminal end 8b distal from the clamp 5, one can decide to connect the handguard at one hole or slot 15a (see FIG. 16), thereby allowing more room for brake reservoirs/controls under the arm with respect to an attachment at the other hole or slot 15b (see FIG. 17), while maintaining the guard in the same position.

The intention of these mounting points is to allow users to adjust rotation of the arm of handguards without moving the handguard itself. This allows users to adjust the handguards to accommodate larger brake calipers/controls without compromising the position of the plastic guards. With both mounting points, the guard remains vertical when in line with the center of the clamp.

5. Quick and Easy Installation and Removal of Grip Mounted Accessories Via a Lock on Grip Clamp that can Stay on the Bike Independently of the Removable Accessories

Another advantageous feature of the kit of the present invention is how it can be easily installed and uninstalled depending on whether the rider wants to use the accessory or handguard on a specific ride.

In this respect, the lock on clamp can be used independently of the accessories or handguards themselves, owing to the presence of mutual connecting components or portions 13, so that the guard arm 8 can be assembled/disassembled to/from the clamp 5 due to such mutual connecting components or portions 13 even after that the clamp 5 has been mounted on a handgrip owing to the element for tightening 7.

Once the new lock on ring has been installed, a user only has to slide the guards into place and tighten 1 bolt to secure the guards.

The present invention has been described according to a preferred embodiment, but equivalent variants can be devised without departing from the scope offered by the following claims.

1. A kit for mounting an accessory on handgrips of a bicycle or motorcycle, comprising:
a clamp to be mounted on handgrips of a bicycle or motorcycle including an outer surface and an inner surface delimiting a through opening extending along a first axis,
at least one element for tightening said clamp or rather the respective inner surface on a handgrip,
an accessory or guard arm enbloc with or fixed or removably mountable on said clamp and designed to support said accessory,
at least one element for connecting an accessory to said guard arm,
at least two shims or spacers having a different thickness and/or shape one with respect to the other, so that the kit is suitable for making it possible to mount an accessory on two or more handgrips with shape and/or size different from one another.

2. The kit as claimed in claim 1, wherein said shims include at least one shim with a main C-shaped section and one or more protruding sections extending from an edge of the main C-shaped section, the main C-shaped section and said one or more protruding sections being designed to be mounted on a handlebar, whereas the one or more protruding sections being designed to be inserted in the inner surface of the clamp, with the main C-shaped section abutting against one of the sides of the clamp.

3. The kit as claimed in claim 2, wherein said main C-shaped section has a thickness, i.e. an extension parallel to the central or longitudinal axis of the shim, which varies from one end to the other, so that it is minimum at the ends and maximum at the central part or viceversa.

4. The kit as claimed in claim 2, wherein said one or more protruding sections has/have a width lower than the width of the main C-shaped section, said one or more protruding sections extending from an inner edge of the main C-shaped section, so that the inner surface delimited by said one or more protruding sections is aligned to the inner surface delimited by the main C-shaped section, whereas the outer surface of said or more protruding sections has a cross-section lower than the inner surface of said clamp, so that the protruding section/s can be inserted and mounted in the inner surface of said clamp.

5. The kit as claimed in claim 1, comprising at least three shims having a different thickness and/or shape one with respect to the other, so that the kit is suitable for making it possible to mount an accessory on at least three handgrips with shape and/or size different from one another.

6. The kit as claimed in claim 1, wherein said inner surface of the clamp defines at least one recessed portion suitable for housing a flanged-like end of a handgrip.

7. The kit as claimed in claim 1, including an accessory, such as for example a handguard, a bell or a flashlight.

8. The kit as claimed in claim 1, wherein said accessory delimits a slot or a number of holes for receiving said at least one element for connecting in a number of positions.

9. A kit for mounting an accessory on handgrips or handlebars of a bicycle or motorcycle, comprising:
a clamp to be mounted on a handgrip or on a handlebar of a bicycle or motorcycle including an outer and an inner surface delimiting a through opening extending along a first axis,
at least one element for tightening said clamp or rather the respective inner surface on a handgrip or a handlebar,
an accessory arm or guard arm removably mountable on said clamp and designed to support said accessory,
at least one element for connecting an accessory to said guard arm,
said accessory arm and said clamp including mutual connecting components or portions, so that said accessory arm can be assembled/disassembled to/from said clamp due to such mutual connecting components or portions even after said clamp has been mounted on a handgrip or a handlebar owing to said at least one element for tightening and thus the assembly/disassembly step of said accessory arm or guard arm to/from said clamp is irrespective from the mounting/dismounting step of said clamp on a handgrip or a handlebar.

10. The kit as claimed in claim 9, wherein said clamp includes a protruding portion or seat, whereas the arm is mountable on said protruding portion or seat by means of at least one screw, bolt or rivet.

11. The kit as claimed in claim 10, wherein said clamp includes a protruding portion, and wherein said kit comprises a plate, said protruding portion being clamped among said plate and said arm, whereas said at least one screw, bolt or rivet is inserted in holes and/or slots aligned of said plate and said arm.

12. The kit as claimed in claim 9, wherein said protruding portion includes a curved rib or said seat includes a curved housing, whereas said arm has an end of connection slidingly mountable along the curved rib or housing, so that the mounting position of the arm with respect to the clamp can be adjusted by sliding the end of connection along the curved rib or housing.

13. The kit as claimed in claim 12, wherein the cross-section of the protruding portion include a base segment directly extending from the outer surface, and a terminal segment larger than the base segment so as to define with the latter a step facing the outer surface, the cross-section of the protruding portion being I-beam-shaped or T-shaped, with the head of the T being constituted by the terminal segment.

14. The kit as claimed in claim 9, wherein said arm delimits at least two connection holes or at least one slot at the terminal end distal from the clamp and designed to constitute a mounting end for an accessory, said at least one element for connecting an accessory to said arm being engageable in each of said at least two connection holes or in said at least one slot, so that it is possible to mount an accessory in at least two different arrangements with respect to the arm.

15. The kit as claimed in claim 14, wherein a first one of the connection holes is formed at a position proximal to the free end of the arm and the other at a position distal from such free end or rather at a distance from the latter greater than the first hole.

16. The kit as claimed in claim 9, including an accessory, such as for example a handguard, a bell or a flashlight, said arm being designed to support said accessory.

17. The kit as claimed in claim 16, wherein said accessory delimits a slot or a number of holes for receiving said at least one element for connecting in a number of positions.

18. A bicycle or motorcycle including a handlebar as well as two handgrips mounted on such handlebar and at least one kit for mounting an accessory on one of said handgrips or on said handlebar, said at least one kit comprising:
an accessory,
a clamp mounted on one handgrip of the bicycle including an outer and an inner surface delimiting a through opening extending along a first axis,
at least one element for tightening said clamp or rather the respective inner surface on one handgrip of the bicycle,
an accessory or guard arm enbloc with or fixed or removably mountable on said clamp and designed to support said accessory,
at least one element for connecting an accessory to said guard arm,
at least one shim or spacer at least partly mounted in said clamp.

19. The bicycle or motorcycle as claimed in claim 18, wherein said at least one shim has a main C-shaped section and one or more protruding sections extending from an edge of the main C-shaped section, the one or more protruding sections being inserted in the inner surface of the clamp, with the main C-shaped section abutting against one of the sides of the clamp.

20. A bicycle or motorcycle including a handlebar as well as two handgrips mounted on such handlebar and at least one kit for mounting an accessory on one of said handgrip or on said handlebar, said at least one kit comprising:
at least one accessory,
a clamp mounted on one handgrip or on the handlebar of the bicycle or motorcycle including an outer and an inner surface delimiting a through opening extending along a first axis,
at least one element for tightening said clamp or rather the respective inner surface on one handgrip or the handlebar,
an accessory arm or guard arm removably mountable on said clamp and designed to support said accessory,
at least one element for connecting an accessory to said guard arm,
said accessory arm and said clamp including mutual connecting components or portions, so that said accessory arm can be assembled/disassembled to/from said clamp due to such mutual connecting components or portions even after said clamp has been mounted on the handgrip or handlebar owing to said at least one element for tightening and thus the assembly/disassembly step of said accessory arm or guard arm to/from said clamp is irrespective from the mounting/dismounting step of said clamp on the handgrip or handlebar.
